(19) United States
(12) Patent Application Publication
(10) Pub. No.: US 2025/0298649 A1
(43) Pub. Date: Sep. 25, 2025

(54) Container Emulator for Kubernetes

(71) Applicant: Rakuten Symphony, Inc., Tokyo (JP)

(72) Inventor: Manjunath Mageswaran, San Jose, CA (US)

(21) Appl. No.: 18/251,831

(22) PCT Filed: Dec. 14, 2022
(86) PCT No.: PCT/US2022/052859

§ 371 Date: May 4, 2023

(51) Int. Cl. G06F 9/455

(52) U.S. Cl. CPC G06F 9/45558; G06F 2009/45575

(57) ABSTRACT

A host receives a request to instantiate a plurality of containers, such as a host of a KUBERNETES pod. The host instantiates application instances of the plurality of containers within a single virtual machine without instantiating the plurality of containers. The CRI for the containers is a container emulator that maintains simulated states for the containers and responds to instructions for the containers. The container emulator performs binding of application instances to processors and the monitoring and reporting of usage information, such as processor time.

### BACKGROUND

### Field of the Invention

This invention relates to a container emulator for improving.

### Background of the Invention

Whether processing ecommerce transactions, streaming content, providing back-end data management for mobile applications, or other services, the modern company requires a large amount of computing resources including processor time, memory, and persistent data storage. The amount of computing resources varies over time. Modern computing installations can dynamically sale up and scale down in order to adapt to changes in usage. For example, Kubernetes is a popular orchestrator for adding and removing instances of applications based on usage. Adding an instance of an application to a host typically includes transmitting, to the host, an executable image including the application and a container for executing the application, which introduces delay. Once executing on a host, the container consumes computing resources in order to perform its function, particularly as this function relates to implementing functionality required by Kubernetes.

It would be an advancement in the art to speed up the deployment of execution of applications in a computing installation.

### SUMMARY OF THE INVENTION

A computing device includes one or more processing devices and one or more memory devices operably coupled to the one or more processing devices. The one or more memory devices store executable code that, when executed by the one or more processing devices, causes the one or more processing devices to receive a request to instantiate a plurality of containers from a source, each container having a corresponding application image of a plurality of application images. In response to the request, the executable code causes the one or more processing devices to instantiate the plurality of application images to obtain a plurality of application instances without instantiating the plurality of containers. Execution of the plurality of containers with respect to the plurality of application instances is emulated in response to instructions from the source.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment for the deployment of applications in accordance with an embodiment;

FIG. 2A is a schematic block diagram showing a conventional approach for implementing containerized applications in accordance with the prior art;

FIG. 2B is a schematic block diagram showing components for emulating a container in accordance with an embodiment;

FIG. 3A is process flow diagram of a method for emulating the instantiation of an application instance in a container in accordance with an embodiment;

FIG. 3B is a process flow diagram of a method for executing an application instance while emulating a container in accordance with an embodiment; and

FIG. 4 is a schematic block diagram of an example computing device suitable for implementing methods in accordance with embodiments of the invention.

### DETAILED DESCRIPTION

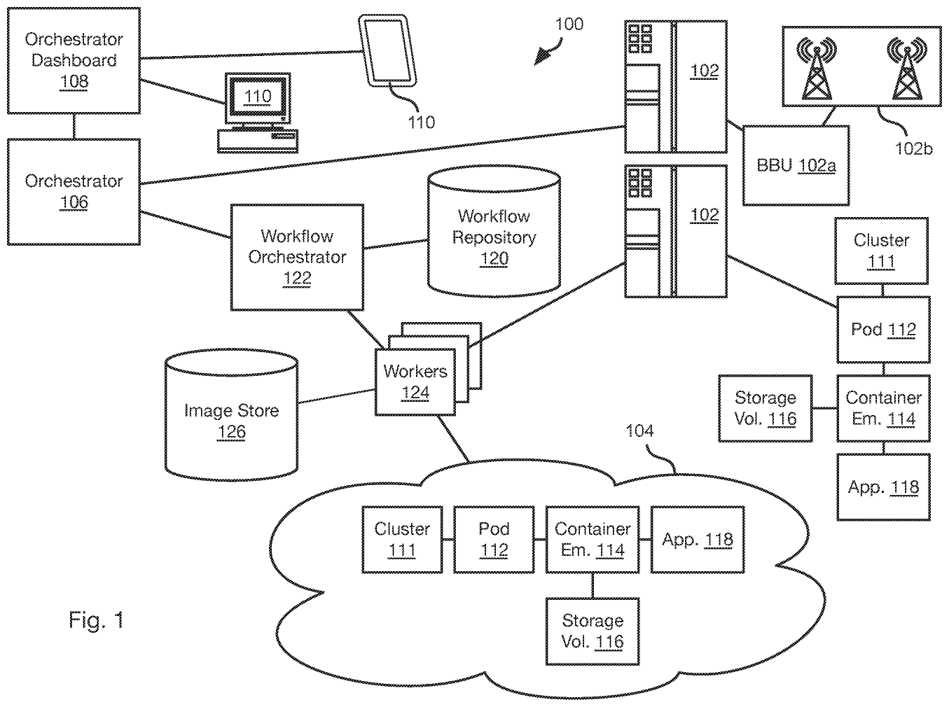

FIG. 1 illustrates an example network environment 100 in which the systems and methods disclosed herein may be used. The components of the network environment 100 may be connected to one another by a network such as a local area network (LAN), wide area network (WAN), the Internet, a backplane of a chassis, or other type of network. The components of the network environment 100 may be connected by wired or wireless network connections.

The network environment 100 includes a plurality of servers 102. Each of the servers 102 may include one or more computing devices, such as a computing device having some or all of the attributes of the computing device 1100 of FIG. 11.

Computing resources may also be allocated within a cloud computing platform 104, such as amazon web services (AWS), GOOGLE CLOUD, AZURE, or other cloud computing platform. Cloud computing resources may include purchased physical storage, processor time, memory, and/or networking bandwidth in units designated by the provider by the cloud computing platform.

In some embodiments, some or all of the servers 102 may function as edge servers in a telecommunication network. For example, some or all of the servers 102 may be coupled to baseband units (BBU) 102a that provide translation between radio frequency signals output and received by antennas 102b and digital data transmitted and received by the servers 102. For example, each BBU 102a may perform this translation according to a cellular wireless data protocol (e.g., 4G, 5G, etc.).

An orchestrator 106 provisions computing resources to application instances of one or more different application executables, such as according to a manifest that defines requirements of computing resources for each application instance. The manifest may define dynamic requirements defining the scaling up of a number of application instances and corresponding computing resources in response to usage. The orchestrator 106 may include or cooperate with a utility such as KUBERNETES to perform dynamic scaling up and scaling down the number of application instances.

An orchestrator 106 may execute on a computer system that is distinct from the servers 102 and may be connected to the servers 102 by a network that requires the use of a destination address for communication, such as using a networking including ethernet protocol, internet protocol (IP), Fibre Channel, or other protocol, including any higher-level protocols built on the previously-mentioned protocols, such as user datagram protocol (UDP), transport control protocol (TCP), or the like.

The orchestrator 106 may cooperate with the servers 102 to initialize and configure the servers 102. For example, each server 102 may cooperate with the orchestrator 106 to obtain a gateway address to use for outbound communication and a source address assigned to the server 102 for use in inbound communication. The server 102 may cooperate with the orchestrator 106 to install an operating system on the server 102. For example, the gateway address and source address may be provided and the operating system installed using the approach described in U.S. application Ser. No. 16/903,266, filed Jun. 16, 2020 and entitled AUTOMATED INITIALIZATION OF SERVERS, which is hereby incorporated herein by reference in its entirety.

The orchestrator 106 may be accessible by way of an orchestrator dashboard 108. The orchestrator dashboard 108 may be implemented as a web server or other server-side application that is accessible by way of a browser or client application executing on a user computing device 110, such as a desktop computer, laptop computer, mobile phone, tablet computer, or other computing device.

The orchestrator 106 may cooperate with the servers 102 in order to provision computing resources of the servers 102 and instantiate components of a distributed computing system on the servers 102 and/or on the cloud computing platform 104. For example, the orchestrator 106 may ingest a manifest defining the provisioning of computing resources to and the instantiation of components such as a cluster 111, pod 112 (e.g., KUBERNETES pod), storage volume 116, and an application instance 118. The orchestrator 106 may then allocate computing resources and instantiate the components according to the manifest.

In conventional approaches, application instances 118 are hosted within containers, such as docker containers. As used herein a “container” may be understood as software that packages all dependencies of an application image so that the application will execute reliably and quickly in any given computing environment. For example, a container may include executable code, runtime, system tools, system libraries, settings, and the like that enable the application image to execute on a host either with or without an underlying operating system. As used herein “host” may be understood to be a server 102 or unit of computing resources in the cloud computing platform 104.

Using the approach described herein, applications instances 118 are instantiated and managed by container emulators 114 that perform some or all of the functions of a container, particularly as relates to containers managed by KUBERNETES, while reducing the computing resources consumed by conventional containers. The orchestrator 106 may therefore coordinate with container emulators 114 in order to instantiate and manage application instances 118 according to the manifest.

The manifest may define requirements such as network latency requirements, affinity requirements (same node, same chassis, same rack, same data center, same cloud region, etc.), anti-affinity requirements (different node, different chassis, different rack, different data center, different cloud region, etc.), as well as minimum provisioning requirements (number of cores, amount of memory, etc.), performance or quality of service (QOS) requirements, or other constraints. The orchestrator 106 may therefore provision computing resources in order to satisfy or approximately satisfy the requirements of the manifest.

The instantiation of components and the management of the components may be implemented by means of workflows. A workflow is a series of tasks, executables, configuration, parameters, and other computing functions that are predefined and stored in a workflow repository 120. A workflow may be defined to instantiate each type of component (cluster 111, pod 112, container emulator 114, storage volume 116, application instance, etc.), monitor the performance of each type of component, repair each type of component, upgrade each type of component, replace each type of component, copy (snapshot, backup, etc.) and restore from a copy each type of component, and other tasks. Some or all of the tasks performed by a workflow may be implemented using KUBERNETES or other utility for performing some or all of the tasks.

The orchestrator 106 may instruct a workflow orchestrator 122 to perform a task with respect to a component. In response, the workflow orchestrator 122 retrieves the workflow from the workflow repository 120 corresponding to the task (e.g., the type of task (instantiate, monitor, upgrade, replace, copy, restore, etc.) and the type of component. The workflow orchestrator 122 then selects a worker 124 from a worker pool and instructs the worker 124 to implement the workflow with respect to a server 102 or the cloud computing platform 104. The instruction from the orchestrator 106 may specify a particular server 102, cloud region or cloud provider, or other location for performing the workflow. The worker 124, which may be a container, then implements the functions of the workflow with respect to the location instructed by the orchestrator 106. In some implementations, the worker 124 may also perform the tasks of retrieving a workflow from the workflow repository 120 as instructed by the workflow orchestrator 122.

In some implementations, the containers implementing the workers 124 are remote from the servers 102 with respect to which the workers 124 implement workflows. The workers 124 may further implement some or all workflows either with or without an agent installed on the server 102 or cloud computing platform 104 that is programmed to cooperate with the workers 124 to implement the workflow. For example, the workers 124 may establish a secure command line interface (CLI) connection to the server 102 or cloud computing platform 104. For example secure shell (ssh), remote login (rlogin), or remote procedure calls (RPC), or other interface provided by the operating system of the server 102 or cloud computing platform 104 may be used to transmit instructions and verify the completion of instructions on the server 102 or cloud computing platform 104. When instantiating a component on a host (i.e., a server 102 or a unit of computing resources on the cloud computing platform) according to a workflow, the workers 124 may retrieve an executable image for the component from an image store 126.

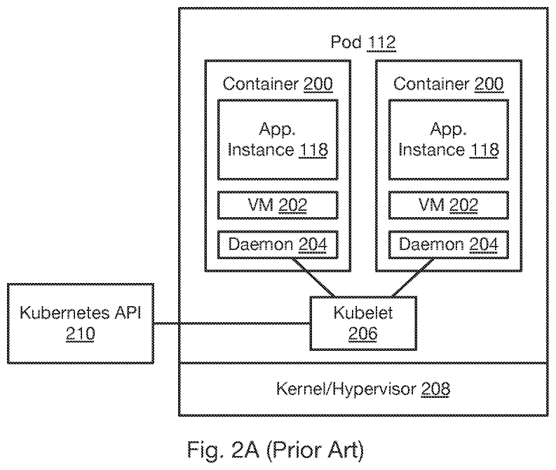

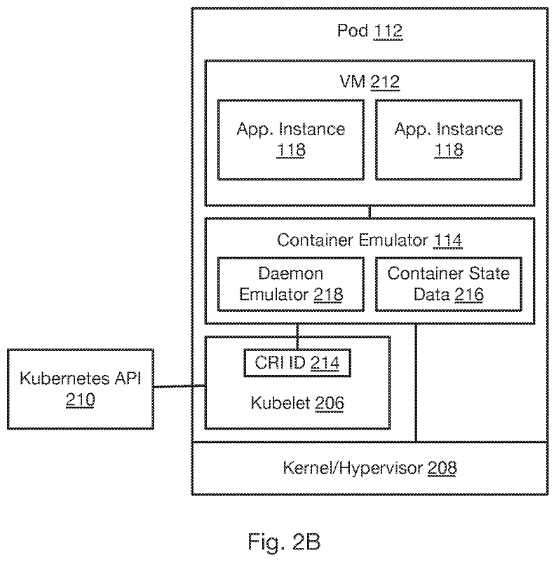

FIG. 2A illustrates a conventional approach for implementing containers 200 instantiated and managed by KUBERNETES. A pod 112 is managed by a Kubelet 206 and includes one or more containers 200. Each container 200 executes a virtual machine 202 providing an execution context for the application instance 118 hosted by the container 200. Each application instance 118 requires its own container 200 and corresponding virtual machine 202. Each container 200 further executes one or more daemons 204, i.e., background processes for performing various management tasks. For example, the daemon 204 may manage binding of the application instance 118 to a particular processing device (e.g., processor core) and further monitor usage of processing time by the application instance 118. The daemon may perform other functions such as monitoring memory and storage usage. The daemon 204 may be an agent of the Kubelet 206 and perform binding to a processing device in response to instructions from the Kubelet 206.

The pod 112 may execute on a server 102 or a unit of computing resources of the cloud computing platform 104. When executing on a server 102, the pod 112 may execute on top of a kernel 208, operating system, or other interface between the pod 112 and the hardware constituting the server 102. Where the pod 112 executes on the cloud computing platform 104, a hypervisor 208 or other component may support execution of the pod 112. A hypervisor 208 may also be present for pods 112 executing on a server 102. As known in the art, a hypervisor is a software component on a host computing device that manages one or more virtual machines executing on the host computing devices and coordinates operation of multiple virtual machines on the host.

The Kubelet 206 itself may receive instructions and report usage by means of a KUBERNETES application programming interface (API) 210 implemented by a KUBERNETES master for a cluster 111 and/or used by the orchestrator 106 to control operation of the containers 200.

The separate virtual machines 202 and separate daemons 204 for each application instance 118 introduce consumption of computing resources that are not available for the application instances 118 thereby limiting the number of application instances 118 that may execute on a given host. This is particularly problematic in telecommunication applications where edge servers 102 may have limited computing resources.

Referring to FIG. 2B, in an improved approach according to the embodiments disclosed herein, a virtual machine 212 instantiated in a pod 112 executes multiple application instances 118, thereby reducing the amount of overhead relative to the prior approach. A container emulator 114 executes in the pod 112. The Kubelet 206 is configured with an identifier 214 (e.g., pointer) of a container runtime interface (CRI) for containers managed by the Kubelet 206. The Kubelet 206 will call the CRI in order to perform tasks relative to containers. In this manner, the Kubelet 206 does not need to have specialized code for each type of container managed by the Kubelet 206. The CRI identifier 214 may refer to the container emulator 114 such that the Kubelet 206 will invoke the container emulator 114 to perform container management tasks.

For example, the Kubelet 206 may call the container emulator 114 to create a container including a virtual machine and daemon (i.e., instantiate a container image including executable code for implementing the virtual machine and daemon) and including an application instance 118. In response, the container emulator 114 instantiates the application instance 118 in the virtual machine 212, which may already be executing an application instance 118 instantiated in the same manner. The container emulator 114 may create an entry in container state data 216 for each application instance 118 executing in the virtual machine 212. The entry may be used to emulate the state of a container though a container does not in fact exist. For example, container state data 216 may record such information as bindings of a particular application instance 118 to a particular processor core, usage statistics including use of processing cycles, memory, and/or storage, or other information. The state of a container may map an identifier of an application instance 118 to a container identifier assigned by the Kubelet 206. The state of a container may further map network connections, network sessions, or other connectivity data to a corresponding application instance 118.

The container emulator 114 may include a daemon emulator 218. The daemon emulator 218 responds to requests from the Kubelet 206 and/or sends reports to the Kubelet 206 spontaneously. For example, the daemon emulator 218 may report processor usage information to the Kubelet 206. The daemon emulator 218 may receive and execute instructions from the Kubelet 206, such as instructions to pause a container, restart a container, instantiate a container, or perform other tasks. In response, the daemon emulator 218 performs the tasks with respect to the application instance 118 corresponding to the container identifier in the instruction, such as by pausing the application instance 118, restarting the application instance 118, instantiate a new application instance 118, or performing other tasks with respect to the application instance 118 and/or the container state corresponding to the application instance 118 in the container state data 216.

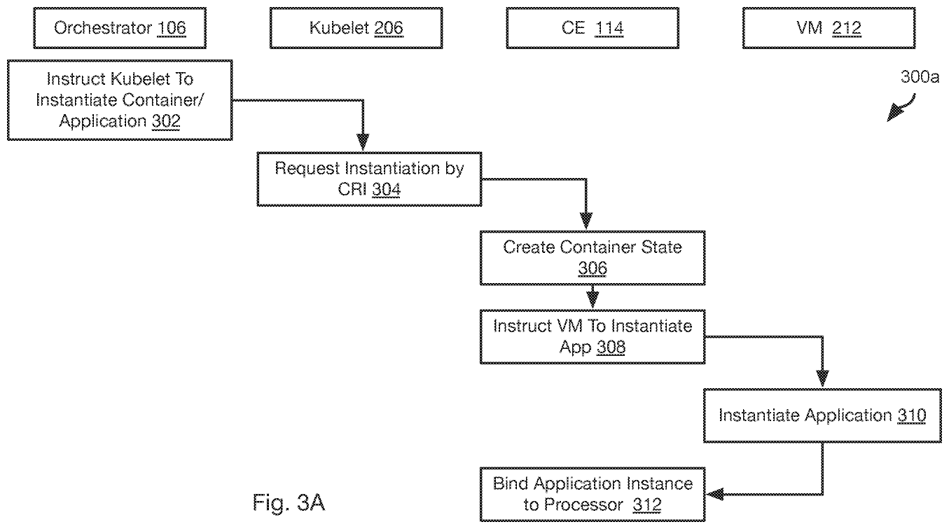

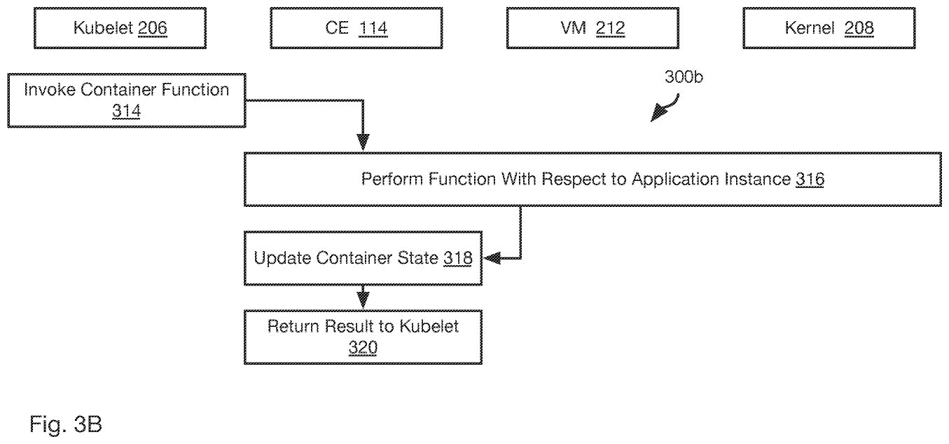

Referring to FIG. 3A, the illustrated method 300a may be used in order to execute multiple application instance 118 within a single virtual machine 212 while still permitting management of the application instances 118 by KUBERNETES.

The method 300a may include the orchestrator 106 instructing 302 the Kubelet 206 to instantiate a container and corresponding application instance 118 on a host. Step 302 may have various alternative implementations. For example, the instruction to instantiate the application instance 118 may be part of an automatic scaling up due to usage such that the instruction is from the KUBERNETES master of a cluster 111.

In response to the instruction from step 302, the Kubelet 206 requests 304 instantiation of the container and corresponding application instance 118 by the container emulator 114 (CE 114), which is referenced by the CRI identifier 214 of the Kubelet 206.

In response to the request, the container emulator 114 creates 308 a new container state in the container state data 216. The new container state may include an identifier of the container included in the instruction from step 302. The container emulator 114 either instantiates 310 the application instance 118 indicated in the instruction or instructs the virtual machine 212 to instantiate 310 the application instance 118. The application image used to instantiate the application instance 118 may be included in the instruction from step 302. Alternatively, an identifier of the application image or an identifier of a container image including the application image is included in the instruction from step 302. The container emulator 114 may then request the application image from the image store 126. Where the identifier is of a container image, the container emulator 114 may either request just the application image or request the entire container image and derive the application image therefrom. The container emulator 114 may store an identifier of the application instance 118 to the container state from step 306, e.g., an identifier of the application instance 118 local to the virtual machine 212 or of a global scope. Where the instruction from step 302 includes an identifier for the application instance 118 this identifier may additionally or alternatively be included in the container state.

The container emulator 114 may perform one or more configuration tasks with respect to the application instance 118. For example, the container emulator 114 may interact with the kernel 208 or hypervisor 208 to bind 312 the application instance 118 to a particular processing device, e.g., a particular processor core of a server 102 or a unit of computing resources including processing resources in the cloud computing platform 104.

FIG. 3B illustrates a method 300b for operating an application instance 118 with the container emulator 114 in order to emulate a container with respect to KUBERNETES. For example, the Kubelet 206 may invoke 314 performance of a container function with respect to an application instance 118 by the container emulator 114 as the CRI that the Kubelet 206 is configured to use. The function may include any container function known in the art, such as an instruction to suspend, restart, stop, perform a health check, report usage of computing resources (processor time, memory, storage) or the like.

The container emulator 114 then performs 316 the function either alone or in cooperation with the virtual machine 212 and/or kernel 208. For example for actions such as suspending, restarting, or stopping the application instance 118 may include translating a container identifier provided by the Kubelet 206 to an identifier of the application instance 118 (e.g., a process identifier) using the container state data 216 and instructing the virtual machine 212 to perform the function (suspending, restarting, stopping) with respect to the identifier of the application instance 118.

The container emulator 114 may then update 318 the container state corresponding to the application instance 118 in the container state data 216 to indicate that the function was complete and return 320 a result to the Kubelet 206, e.g., an acknowledgment that the function was completed successfully.

In another example, the container function is a request for usage information (processor time, memory, storage) for a container identifier. The container emulator 114 may then translate the container identifier to an application identifier and retrieve the usage information for the application identifier. For example, the container emulator 114 may request the usage information from the kernel 208 in response to the request for usage information and return 320 to the usage information to the Kubelet 206. For example, the request may be a request for ongoing collection of usage information for a container identifier mapped to an identifier application instance 118. The container emulator 114 may then store usage information in the container state of the container state data 216 in association with the container identifier. The container emulator 114 may then periodically return 320 reports of the usage information to the Kubelet 206 or return 320 reports of the usage information to the Kubelet 206 in response to an instruction from the Kubelet 206.

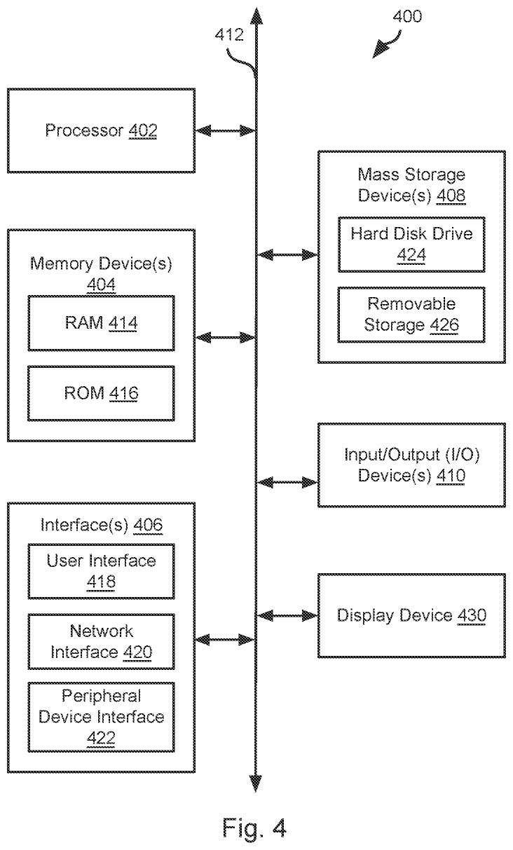

FIG. 4 is a block diagram illustrating an example computing device 400. Computing device 400 may be used to perform various procedures, such as those discussed herein. The servers 102, orchestrator 106, workflow orchestrator 122, and cloud computing platform 104 may each be implemented using one or more computing devices 400. The orchestrator 106 and workflow orchestrator 122 may be implemented on different computing devices 400 or a single computing device 400 may host both of the orchestrator 106 and workflow orchestrator 122.

Computing device 400 includes one or more processor(s) 402, one or more memory device(s) 404, one or more interface(s) 406, one or more mass storage device(s) 408, one or more Input/output (I/O) device(s) 410, and a display device 430 all of which are coupled to a bus 412. Processor(s) 402 include one or more processors or controllers that execute instructions stored in memory device(s) 404 and/or mass storage device(s) 408. Processor(s) 402 may also include various types of computer-readable media, such as cache memory.

Memory device(s) 404 include various computer-readable media, such as volatile memory (e.g., random access memory (RAM) 414) and/or nonvolatile memory (e.g., read-only memory (ROM) 416). Memory device(s) 404 may also include rewritable ROM, such as Flash memory.

Mass storage device(s) 408 include various computer readable media, such as magnetic tapes, magnetic disks, optical disks, solid-state memory (e.g., Flash memory), and so forth. As shown in FIG. 4, a particular mass storage device is a hard disk drive 424. Various drives may also be included in mass storage device(s) 408 to enable reading from and/or writing to the various computer readable media. Mass storage device(s) 408 include removable media 426 and/or non-removable media.

I/O device(s) 410 include various devices that allow data and/or other information to be input to or retrieved from computing device 400. Example I/O device(s) 410 include cursor control devices, keyboards, keypads, microphones, monitors or other display devices, speakers, printers, network interface cards, modems, lenses, CCDs or other image capture devices, and the like.

Display device 430 includes any type of device capable of displaying information to one or more users of computing device 400. Examples of display device 430 include a monitor, display terminal, video projection device, and the like.

Interface(s) 406 include various interfaces that allow computing device 400 to interact with other systems, devices, or computing environments. Example interface(s) 406 include any number of different network interfaces 420, such as interfaces to local area networks (LANs), wide area networks (WANs), wireless networks, and the Internet. Other interface(s) include user interface 418 and peripheral device interface 422. The interface(s) 406 may also include one or more peripheral interfaces such as interfaces for printers, pointing devices (mice, track pad, etc.), keyboards, and the like.

Bus 412 allows processor(s) 402, memory device(s) 404, interface(s) 406, mass storage device(s) 408, I/O device(s) 410, and display device 430 to communicate with one another, as well as other devices or components coupled to bus 412. Bus 412 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 400, and are executed by processor(s) 402. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. An apparatus comprising:
a computing device including one or more processing devices and one or more memory devices operably coupled to the one or more processing devices, the one or more memory devices storing executable code that, when executed by the one or more processing devices, causes the one or more processing devices to:
receive a request to instantiate a plurality of containers from a source, each container having a corresponding application image of a plurality of application images; and
in response to the request:
instantiate the plurality of application images to obtain a plurality of application instances without instantiating the plurality of containers; and
emulate execution of the plurality of containers with respect to the plurality of application instances in response to instructions from the source.

2. The apparatus of claim 1, wherein the executable code, when executed by the one or more processing devices, further causes the one or more processing devices to:
instantiate the plurality of application instances in a single virtual machine.

3. The apparatus of claim 2, wherein each container of the plurality of containers includes a virtual machine.

4. The apparatus of claim 1, wherein the one or more processing devices are a plurality of processing devices; and
wherein the executable code, when executed by the one or more processing devices, further causes the plurality of processing devices to:
bind each application instance of the plurality of application instances to a processing device of the plurality of processing devices.

5. The apparatus of claim 1, wherein the one or more processing devices are a plurality of processing devices; and
wherein the executable code, when executed by the one or more processing devices, further causes the plurality of processing devices to:
cooperate with a kernel executing on the plurality of processing devices to bind each application instance of the plurality of application instances to a processing device of the plurality of processing devices.

6. The apparatus of claim 1, wherein the executable code, when executed by the one or more processing devices, further causes the one or more processing devices to:
perform collection of usage data for the plurality of application instances.

7. The apparatus of claim 6, wherein the usage data is processor usage data.

8. The apparatus of claim 6, wherein the executable code, when executed by the one or more processing devices, further causes the one or more processing devices to collect the usage data using a daemon executing on the one or more processing devices.

9. The apparatus of claim 6, wherein the executable code, when executed by the one or more processing devices, further causes the one or more processing devices to:
emulate execution of the plurality of containers with respect to the plurality of application instances in response to instructions from the source by returning the usage data to the source.

10. The apparatus of claim 1, wherein the source implements KUBERNETES.

11. A method comprising:
receiving, by a computer system, a request to instantiate a plurality of containers from a source, each container having a corresponding application image of a plurality of application images; and
in response to the request:
instantiating, by the computer system, the plurality of application images to obtain a plurality of application instances without instantiating the plurality of containers; and
emulating, by the computer system, execution of the plurality of containers with respect to the plurality of application instances in response to instructions from the source.

12. The method of claim 11, wherein instantiating the plurality of application images comprises instantiating the plurality of application instances in a single virtual machine.

13. The method of claim 12, wherein each container of the plurality of containers includes a virtual machine.

14. The method of claim 11, further comprising binding, by the computer system, each application instance of the plurality of application instances to a processing device of a plurality of processing devices of the computer system,.

15. The method of claim 11, further comprising:
cooperating, by the computer system, with a kernel executing on the computer system to bind each application instance of the plurality of application instances to a processing device of a plurality of processing devices.

16. The method of claim 11, further comprising performing collection of usage data for the plurality of application instances.

17. The method of claim 16, wherein the usage data is processor usage data.

18. The method of claim 16, further comprising, collecting the usage data using a daemon executing on the computer system.

19. The method of claim 16, further comprising emulating execution of the plurality of containers with respect to the plurality of application instances in response to instructions from the source by returning the usage data to the source.

20. The method of claim 11, wherein the source implements KUBERNETES.
